(19) United States
(12) Patent Application Publication
(10) Pub. No.: US 2015/0159077 A1
(43) Pub. Date: Jun. 11, 2015

(54) Henna Corrosion Inhibitor for Acid in a Well

(71) Applicant: Halliburton Energy Services, Inc., Houston, TX (US)

(72) Inventors: Garima Shankar Misra, Kanpur (IN); Prajakta Ratnakar Patil, Pune (IN)

(21) Appl. No.: 14/522,933

(22) Filed: Oct. 24, 2014

Related U.S. Application Data
(63) Continuation of application No. 13/901,730, filed on May 24, 2013.

(51) Int. Cl. C09K 8/54; E21B 41/02

(52) U.S. Cl. CPC C09K 8/54; E21B 41/02; C09K 2208/32

(57) ABSTRACT

A method of treating a portion of a well including the steps of: (A) forming a fluid comprising: (i) an aqueous liquid phase; and (ii) a corrosion inhibitor selected from the group consisting of: (a) the leaves of henna, jewelweed, or any combination thereof; (b) an extract of the leaves of henna, jewelweed, or any combination thereof; (c) a plant source of a hydroxynaphthoquinone; (d) a hydroxynaphthoquinone; and (e) any combination an any of the foregoing; and (B) introducing the fluid into the portion of the well.

### CROSS-REFERENCE TO RELATED APPLICATIONS

This application is a continuation of U.S. Non-Provisional patent application Ser. No. 13/901,730, filed May 24, 2013, entitled “Henna Corrosion Inhibitor for Acid in a Well,” which is hereby incorporated by reference in its entirety.

### TECHNICAL FIELD

The inventions are in the field of producing crude oil or natural gas from subterranean formations. More particularly, the inventions relate to corrosion inhibition of carbon steel with the use of an acid in a well.

### SUMMARY OF THE INVENTION

A method of treating a portion of a well is provided, the method including the steps of: (A) forming a fluid comprising: (i) an aqueous liquid phase; and (ii) a corrosion inhibitor selected from the group consisting of: (a) the leaves of henna, jewelweed, or any combination thereof; (b) an extract of the leaves of henna, jewelweed, or any combination thereof; (c) a plant source of a hydroxynaphthoquinone; (d) a hydroxynaphthoquinone; and (e) any combination an any of the foregoing; and (B) introducing the fluid into the portion of the well.

These and other aspects of the invention will be apparent to one skilled in the art upon reading the following detailed description. While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

### DETAILED DESCRIPTION OF PRESENTLY PREFERRED EMBODIMENTS AND BEST MODE

### Definitions and Usages

Interpretation

The words or terms used herein have their plain, ordinary meaning in the field of this disclosure, except to the extent explicitly and clearly defined in this disclosure or unless the specific context otherwise requires a different meaning.

If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

Wells, Well Servicing, and Fluids

To produce oil or gas from a reservoir, a wellbore is drilled into a subterranean formation, which may be a reservoir or adjacent to the reservoir.

Generally, well services include a wide variety of operations that may be performed in oil, gas, geothermal, or water wells, such as drilling, cementing, completion, and intervention. Well services are designed to facilitate or enhance the production of desirable fluids such as oil or gas from or through a subterranean formation. A well service usually involves introducing a fluid into a well.

A “well” includes a wellhead and at least one wellbore from the wellhead penetrating the earth. The “wellhead” is the surface termination of a wellbore, which surface may be on land or on a seabed. A “well site” is the geographical location of a wellhead of a well. It may include related facilities, such as a tank battery, separators, compressor stations, heating or other equipment, and fluid pits. If offshore, a well site can include a platform.

The “wellbore” refers to the drilled hole, including any cased or uncased portions of the well or any other tubulars in the well. The “borehole” usually refers to the inside wellbore wall, that is, the rock surface or wall that bounds the drilled hole. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

A wellbore can be used as a production or injection wellbore. A production wellbore is used to produce hydrocarbons from the reservoir. An injection wellbore is used to inject a fluid, e.g., liquid water or steam, to drive oil or gas to a production wellbore.

As used herein, introducing “into a well” means introducing at least into and through the wellhead. According to various techniques known in the art, tubulars, equipment, tools, or fluids can be directed from the wellhead into any desired portion of the wellbore.

As used herein, the word “tubular” means any kind of structural body in the general form of a tube. Examples of tubulars include, but are not limited to, a drill pipe, a casing, a tubing string, a line pipe, and a transportation pipe.

A fluid can be, for example, a drilling fluid, a cementing composition, a treatment fluid, or a spacer fluid. If a fluid is to be used in a relatively small volume, for example less than about 200 barrels (about 8,400 US gallons or about 32 m³), it is sometimes referred to as a wash, dump, slug, or pill.

As used herein, the word “treatment” refers to any treatment for changing a condition of a portion of a wellbore, or a subterranean formation adjacent a wellbore; however, the word “treatment” does not necessarily imply any particular treatment purpose. A treatment usually involves introducing a fluid for the treatment, in which case it may be referred to as a treatment fluid, into a well. As used herein, a “treatment fluid” is a fluid used in a treatment. The word “treatment” in the term “treatment fluid” does not necessarily imply any particular treatment or action by the fluid.

A “portion” of a well refers to any downhole portion of the well.

A “zone” refers to an interval of rock along a wellbore that is differentiated from uphole and downhole zones based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.” A “treatment zone” refers to an interval of rock along a wellbore into which a fluid is directed to flow from the wellbore. As used herein, “into a treatment zone” means into and through the wellhead and, additionally, through the wellbore and into the treatment zone.

As used herein, a “downhole” fluid is an in-situ fluid in a well, which may be the same as a fluid at the time it is introduced, or a fluid mixed with another fluid downhole, or a fluid in which chemical reactions are occurring or have occurred in-situ downhole.

Generally, the greater the depth of the formation, the higher the static temperature and pressure of the formation. Initially, the static pressure equals the initial pressure in the formation before production. After production begins, the static pressure approaches the average reservoir pressure.

A “design” refers to the estimate or measure of one or more parameters planned or expected for a particular fluid or stage of a well service or treatment. For example, a fluid can be designed to have components that provide a minimum density or viscosity for at least a specified time under expected downhole conditions. A well service may include design parameters such as fluid volume to be pumped, required pumping time for a treatment, or the shear conditions of the pumping.

The term “design temperature” refers to an estimate or measurement of the actual temperature at the downhole environment during the time of a treatment. For example, the design temperature for a well treatment takes into account not only the bottom hole static temperature (“BHST”), but also the effect of the temperature of the fluid on the BHST during treatment. The design temperature for a fluid is sometimes referred to as the bottom hole circulation temperature (“BHCT”). Because fluids may be considerably cooler than BHST, the difference between the two temperatures can be quite large. Ultimately, if left undisturbed, a subterranean formation will return to the BHST.

Substances, Polymers, and Derivatives

A substance can be a pure chemical or a mixture of two or more different chemicals.

As used herein, a “polymer” or “polymeric material” includes polymers, copolymers, terpolymers, etc. In addition, the term “copolymer” as used herein is not limited to the combination of polymers having two monomeric units, but includes any combination of monomeric units, e.g., terpolymers, tetrapolymers, etc.

As used herein, “modified” or “derivative” means a chemical compound formed by a chemical process from a parent compound, wherein the chemical backbone skeleton of the parent compound is retained in the derivative. The chemical process preferably includes at most a few chemical reaction steps, and more preferably only one or two chemical reaction steps. As used herein, a “chemical reaction step” is a chemical reaction between two chemical reactant species to produce at least one chemically different species from the reactants (regardless of the number of transient chemical species that may be formed during the reaction). An example of a chemical step is a substitution reaction. Substitution on the reactive sites of a polymeric material may be partial or complete.

Physical States and Phases

As used herein, “phase” is used to refer to a substance having a chemical composition and physical state that is distinguishable from an adjacent phase of a substance having a different chemical composition or a different physical state.

As used herein, if not other otherwise specifically stated, the physical state or phase of a substance (or mixture of substances) and other physical properties are determined at a temperature of 77° F. (25° C.) and a pressure of 1 atmosphere (Standard Laboratory Conditions) without applied shear.

Particles and Particulate

As used herein, a “particle” refers to a body having a finite mass and sufficient cohesion such that it can be considered as an entity but having relatively small dimensions. A particle can be of any size ranging from molecular scale to macroscopic, depending on context.

A particle can be in any physical state. For example, a particle of a substance in a solid state can be as small as a few molecules on the scale of nanometers up to a large particle on the scale of a few millimeters, such as large grains of sand Similarly, a particle of a substance in a liquid state can be as small as a few molecules on the scale of nanometers up to a large drop on the scale of a few millimeters.

As used herein, particulate or particulate material refers to matter in the physical form of distinct particles in a solid or liquid state (which means such an association of a few atoms or molecules). As used herein, a particulate is a grouping of particles having similar chemical composition and particle size ranges anywhere in the range of about 0.5 micrometer (500 nm), e.g., microscopic clay particles, to about 3 millimeters, e.g., large grains of sand.

A particulate can be of solid or liquid particles. As used herein, however, unless the context otherwise requires, particulate refers to a solid particulate.

It should be understood that the terms “particle” and “particulate,” includes all known shapes of particles including substantially rounded, spherical, oblong, ellipsoid, rod-like, fiber, polyhedral (such as cubic materials), etc., and mixtures thereof. For example, the term “particulate” as used herein is intended to include solid particles having the physical shape of platelets, shavings, flakes, ribbons, rods, strips, spheroids, toroids, pellets, tablets or any other physical shape.

Dispersions

A dispersion is a system in which particles of a substance of one chemical composition and physical state are dispersed in another substance of a different chemical composition or physical state. In addition, phases can be nested. If a substance has more than one phase, the most external phase is referred to as the continuous phase of the substance as a whole, regardless of the number of different internal phases or nested phases.

A dispersion is considered to be heterogeneous if the dispersed particles are not dissolved and are greater than about 1 nanometer in size. (For reference, the diameter of a molecule of toluene is about 1 nm and a molecule of water is about 0.3 nm).

Heterogeneous dispersions can have gas, liquid, or solid as an external phase. For example, in a case where the dispersed-phase particles are liquid in an external phase that is another liquid, this kind of heterogeneous dispersion is more particularly referred to as an emulsion. A solid dispersed phase in a continuous liquid phase is referred to as a sol, suspension, or slurry, partly depending on the size of the dispersed solid particulate.

A dispersion is considered to be homogeneous if the dispersed particles are dissolved in solution or the particles are less than about 1 nanometer in size. Even if not dissolved, a dispersion is considered to be homogeneous if the dispersed particles are less than about 1 nanometer in size.

A solution is a special type of homogeneous mixture. A solution is considered homogeneous: (a) because the ratio of solute to solvent is the same throughout the solution; and (b) because solute will never settle out of solution, even under powerful centrifugation, which is due to intermolecular attraction between the solvent and the solute. An aqueous solution, for example, saltwater, is a homogenous solution in which water is the solvent and salt is the solute.

Solubility

A substance is considered to be “soluble” in a liquid if at least 10 grams of the substance can be dissolved in one liter of the liquid when tested at 77° F. and 1 atmosphere pressure for 2 hours and considered to be “insoluble” if less than 1 gram per liter soluble and “sparingly soluble” for intermediate solubility values.

As will be appreciated by a person of skill in the art, the hydratability, dispersibility, or solubility of a substance in water can be dependent on the salinity, pH, or other substances in the water. Accordingly, the salinity, pH, and additive selection of the water can be modified to facilitate the hydratability, dispersibility, or solubility of a substance in aqueous solution. To the extent not specified, the hydratability, dispersibility, or solubility of a substance in water is determined in deionized water, at neutral pH, and without any other additives.

The “source” of a chemical species in a solution or in a fluid composition can be a material or substance that makes the chemical species chemically available immediately or it can be a material or substance that gradually or later releases the chemical species to become chemically available.

Fluids

A fluid can be a single phase or a dispersion. In general, a fluid is an amorphous substance that is or has a continuous phase of particles that are smaller than about 1 micrometer that tends to flow and to conform to the outline of its container.

Examples of fluids are gases and liquids. A gas (in the sense of a physical state) refers to an amorphous substance that has a high tendency to disperse (at the molecular level) and a relatively high compressibility. A liquid refers to an amorphous substance that has little tendency to disperse (at the molecular level) and relatively high incompressibility. The tendency to disperse is related to Intermolecular Forces (also known as van der Waal's Forces). (A continuous mass of a particulate, e.g., a powder or sand, can tend to flow as a fluid depending on many factors such as particle size distribution, particle shape distribution, the proportion and nature of any wetting liquid or other surface coating on the particles, and many other variables. Nevertheless, as used herein, a fluid does not refer to a continuous mass of particulate as the sizes of the solid particles of a mass of a particulate are too large to be appreciably affected by the range of Intermolecular Forces.)

As used herein, a fluid is a substance that behaves as a fluid under Standard Laboratory Conditions, that is, at 77° F. (25° C.) temperature and 1 atmosphere pressure, and at the higher temperatures and pressures usually occurring in subterranean formations without applied shear.

Every fluid inherently has at least a continuous phase. A fluid can have more than one phase. Examples of fluids include a suspension (solid particles dispersed in a liquid phase), an emulsion (liquid particles dispersed in another liquid phase), or a foam (a gas phase dispersed in a liquid phase).

As used herein, a water-based fluid means that water or an aqueous solution is the dominant material of the continuous phase, that is, greater than 50% by weight, of the continuous phase of the fluid.

In contrast, “oil-based” means that oil is the dominant material by weight of the continuous phase of the fluid. In this context, the oil of an oil-based fluid can be any oil.

In the context of a fluid, oil is understood to refer to an oil liquid, whereas gas is understood to refer to a physical state of a substance, in contrast to a liquid. In general, an oil is any substance that is liquid under Standard Laboratory Conditions, is hydrophobic, and soluble in organic solvents. Oils have a high carbon and hydrogen content and are relatively non-polar substances, for example, having a polarity of 3 or less on the Snyder polarity index. This general definition includes classes such as petrochemical oils, vegetable oils, and many organic solvents. All oils can be traced back to organic sources.

Apparent Viscosity of a Fluid

Viscosity is a measure of the resistance of a fluid to flow. In everyday terms, viscosity is “thickness” or “internal friction.” Thus, pure water is “thin,” having a relatively low viscosity whereas honey is “thick,” having a relatively higher viscosity. Put simply, the less viscous the fluid is, the greater its ease of movement (fluidity). More precisely, viscosity is defined as the ratio of shear stress to shear rate.

A fluid moving along solid boundary will incur a shear stress on that boundary. The no-slip condition dictates that the speed of the fluid at the boundary (relative to the boundary) is zero, but at some distance from the boundary the flow speed must equal that of the fluid. The region between these two points is named the boundary layer.

A Newtonian fluid (named after Isaac Newton) is a fluid for which stress versus strain rate curve is linear and passes through the origin. The constant of proportionality is known as the viscosity. Examples of Newtonian fluids include water and most gases. Newton's law of viscosity is an approximation that holds for some substances but not others.

Non-Newtonian fluids exhibit a more complicated relationship between shear stress and velocity gradient (i.e., shear rate) than simple linearity.

Most fluids are non-Newtonian fluids. Accordingly, the apparent viscosity of a fluid applies only under a particular set of conditions including shear stress versus shear rate, which must be specified or understood from the context. As used herein, a reference to viscosity is actually a reference to an apparent viscosity. Apparent viscosity is commonly expressed in units of centipoise (“cP”).

Like other physical properties, the viscosity of a Newtonian fluid or the apparent viscosity of a non-Newtonian fluid may be highly dependent on the physical conditions, primarily temperature and pressure.

Gels and Deformation

The physical state of a gel is formed by a network of interconnected molecules, such as a crosslinked polymer or a network of micelles. The network gives a gel phase its structure and an apparent yield point. At the molecular level, a gel is a dispersion in which both the network of molecules is continuous and the liquid is continuous. A gel is sometimes considered as a single phase.

Technically, a “gel” is a semi-solid, jelly-like physical state or phase that can have properties ranging from soft and weak to hard and tough. Shearing stresses below a certain finite value fail to produce permanent deformation. The minimum shear stress which will produce permanent deformation is referred to as the shear strength or gel strength of the gel.

In the oil and gas industry, however, the term “gel” may be used to refer to any fluid having a viscosity-increasing agent, regardless of whether it is a viscous fluid or meets the technical definition for the physical state of a gel.

As used herein, a substance referred to as a “gel” is subsumed by the concept of “fluid” if it is a pumpable fluid.

Biodegradability

Biodegradable means the process by which complex molecules are broken down by micro-organisms to produce simpler compounds. Biodegradation can be either aerobic (with oxygen) or anaerobic (without oxygen). The potential for biodegradation is commonly measured on fluids or their components to ensure that they do not persist in the environment. A variety of tests exist to assess biodegradation.

As used herein, a substance is considered “biodegradable” if the substance passes a ready biodegradability test or an inherent biodegradability test. It is preferred that a substance is first tested for ready biodegradability, and only if the substance does not pass at least one of the ready biodegradability tests then the substance is tested for inherent biodegradability.

In accordance with Organisation for Economic Co-operation and Development (OECD) guidelines, the following six tests permit the screening of chemicals for ready biodegradability. As used herein, a substance showing more than 60% biodegradability in 28 days according to any one of the six ready biodegradability tests is considered a pass level for classifying it as “readily biodegradable,” and it may be assumed that the substance will undergo rapid and ultimate degradation in the environment. The six ready biodegradability tests are: (1) 301A: DOC Die-Away; (2) 301B: CO2 Evolution (Modified Sturm Test); (3) 301C: MITI (I) (Ministry of International Trade and Industry, Japan); (4) 301D: Closed Bottle; (5) 301E: Modified OECD Screening; and (6) 301F: Manometric Respirometry.

In accordance with OECD guidelines, the following three tests permit the testing of chemicals for inherent biodegradability. As used herein, a substance with a biodegradation or biodegradation rate of >20% is regarded as “inherently primary biodegradable.” A substance with a biodegradation or biodegradation rate of >70% is regarded as “inherently ultimate biodegradable.” As used herein, a substance passes the inherent biodegradability test if the substance is either regarded as inherently primary biodegradable or inherently ultimate biodegradable when tested according to any one of three inherent biodegradability tests. The three tests are: (1) 302A: 1981 Modified SCAS Test; (2) 302B: 1992 Zahn-Wellens Test; and (3) 302C: 1981 Modified MITI Test. Inherent biodegradability refers to tests which allow prolonged exposure of the test compound to microorganisms, a more favorable test compound to biomass ratio, and chemical or other conditions which favor biodegradation.

General Measurement Terms

Unless otherwise specified or unless the context otherwise clearly requires, any ratio or percentage means by weight.

Unless otherwise specified or unless the context otherwise clearly requires, the phrase “by weight of the water” means the weight of the water of the continuous phase of the fluid without the weight of any viscosity-increasing agent, dissolved salt, suspended particulate, or other materials or additives that may be present in the water.

As used herein, “% wt/vol” means the mass-volume percentage, sometimes referred to as weight-volume percentage or percent weight per volume and abbreviated as % m/v or % w/v, which describes the mass of the solute in g per 100 mL of the liquid. Mass-volume percentage is often used for solutions made from a solid solute dissolved in a liquid.

If there is any difference between U.S. or Imperial units, U.S. units are intended. For example, “gal/Mgal” means U.S. gallons per thousand U.S. gallons.

The micrometer (μm) may sometimes be referred to herein as a micron.

### General Approach

The purpose of this invention is to provide environmentally friendly materials and compounds that decrease corrosion of metal, particularly carbon steel, caused by drilling or treatment fluids an acid or delayed-release acid.

The problem of corrosion is encountered with any drilling or treatment fluid that includes an acid. Corrosion tendencies and rates using organic acids are relatively lower than for strong mineral acids, but not negligible. In addition, all corrosion rates tend to increase substantially at elevated temperatures. Particularly challenging is the development of new chemistries that maintain good protection of steel under a variety of conditions while being environmentally acceptable.

The problem of corrosion is encountered, for example, in delayed-release acid breaking of filtercakes or other forms of formation damage that may be formed or caused, for example, during the drill-in operations. In addition, it can be encountered in the breaking of the viscosity of a treatment fluid using a delayed-release acid.

In an embodiment, a method of treating a portion of a well is provided, the method including the steps of: (A) forming a fluid comprising: (i) an aqueous liquid phase; and (ii) a corrosion inhibitor selected from the group consisting of: (a) the leaves of henna, jewelweed, or any combination thereof; (b) an extract of the leaves of henna, jewelweed, or any combination thereof; (c) a plant source of a hydroxynaphthoquinone; (d) a hydroxynaphthoquinone; and (e) any combination an any of the foregoing; and (B) introducing the fluid into the portion of the well. These corrosion inhibitors are eco-friendly and naturally occurring substances. The fluid can optionally include an acid or delayed-release acid.

For example, this methods can be used for applications using a delayed-release acid of a slow-acting acid produced in situ for removal of calcium carbonate in a filtercake. In addition, it includes applications of breaking of the viscosity of a treatment fluid using a delayed-release acid after it is placed downhole in a well. Other applications are contemplated, as will be appreciated by a person of skill in the art.

Aqueous Phase

The fluid for use in the invention is preferably a water-based fluid. It should be appreciated, however, that the fluid can be an emulsion for certain applications in a well, either an oil-in-water emulsion or a water-in-oil emulsion.

The aqueous liquid phase of the fluid can optionally include a water-soluble inorganic salt. Such salts can have various purposes in a fluid. For example, a salt can be used as a weighting agent. By way of another example, a salt can be used to help stabilize the rock of a subterranean formation when it contacts water. The salt can be dissolved in the water phase of a fluid. The water-soluble salt can be, for example, selected from the group consisting of alkali metal halides, such as KCl or NaCl, which are commonly used in fluids adapted for us in wells. Another commonly used salt used as a weighting agent is barium sulfate. Unfortunately, dissolved salts can also exacerbate corrosion of certain metals.

In an embodiment, the pH of the aqueous phase is less than about 4.

In another embodiment, the pH of the treatment fluid is initially greater than about 6. Most preferably, the pH at the time of forming the fluid is in the range of about 6 to about 8. In an embodiment having a pH greater than about 6, the fluid can optionally include a delayed-release acid.

Mineral Acids and Organic Acids

Mineral acids tend to dissociate in water more easily than organic acids, to produce H⁺ ions and decrease the pH of the solution. Organic acids tend to dissociate more slowly than mineral acids and less completely.

Relative acid strengths for Bronsted-Lowry acids are expressed by the dissociation constant (pKa). A given acid will give up its proton to the base of an acid with a higher pKa value. The bases of a given acid will deprotonate an acid with a lower pKa value. In case there is more than one acid functionality for a chemical, “pKa(1)” makes it clear that the dissociation constant relates to the first dissociation.

The pKa of acids plays important role in above activities as shown in Table 1.

TABLE 1

| | Acid | Base | pKa(1) |
|---|---|---|---|
| Strong Acids | HCIO₄ | CIO₄⁻ | −10 |
| In Water | HI | I⁻ | −10 |
| | H₂SO₄ | HSO₄⁻ | −10 |
| | HBr | Br⁻ | −9 |
| | HCI | CI⁻ | −7 |
| | HNO₃ | NO₃⁻ | −2 |
| | H₃O⁺ | H₂O | −1.74 |
| Weak Acids | CCI₃CO₂H | CCI₃CO₂⁻ | 0.52 |
| In Water | HSO₄⁻ | SO₄⁻² | 1.99 |
| | H₃PO₄ | H₂PO₄⁻ | 2.12 |
| | CH₂CICO₂H | CH₂CICO₂⁻ | 2.85 |
| | HF | F⁻ | 3.17 |
| | HNO₂ | NO₂⁻ | 3.3 |
| | CH₃CO₂H | CH₃CO₂⁻ | 4.75 |
| | C₅H₅NH⁺ | C₅H₅N | 5.25 |
| | H₂CO₃ | HCO₃⁻ | 6.35 |
| | H₂S | HS⁻ | 7.0 |
| | NH₄⁺ | NH₃ | 9.24 |
| | HCO₃⁻ | CO₃⁻² | 10.33 |
| | CH₃NH₃⁺ | CH₃NH₂ | 10.56 |
| | H₂O | OH⁻ | 15.74 |

Water (H₂O) is the base of the hydronium ion, H₃O⁺, which has a pka −1.74. An acid having a pKa less than that of hydronium ion, pKa −1.74, is considered a strong acid.

For example, hydrochloric acid (HCl) has a pKa −7, which is greater than the pKa of the hydronium ion, pKa −1.74. This means that HCl will give up its protons to water essentially completely to form the H₃O⁺ cation. For this reason, HCl is classified as a strong acid in water. One can assume that all of the HCl in a water solution is 100% dissociated, meaning that both the hydronium ion concentration and the chloride ion concentration correspond directly to the amount of added HCl.

Acetic acid (CH₃CO₂H) has a pKa of 4.75, greater than that of the hydronium ion, but less than that of water itself, 15.74. This means that acetic acid can dissociate in water, but only to a small extent. Thus, acetic acid is classified as a weak acid.

Delayed-Release Acid

In an embodiment, the fluid includes a delayed release acid. An example of a delayed-release acid is an acid precursor such as a carboxylate ester.

Carboxylate ester systems are designed to be effective in attacking the filtercake but to avoid the drawbacks associated with live acid. The basic concept behind the carboxylate ester approach is to treat the filtercake with a solution that is essentially pH neutral and can be placed over the entire productive interval without significant interaction with the filtercake. So there is minimal risk of localized removal of the cake. The carboxylate ester fluid comprises:

A solution of an carboxylate ester as an acid precursor that will react slowly with the water in the carrier water or brine to release an organic acid, which preferably has a pKa(1) of at least 3.75. More preferably, the pKa(1) is in the range of 3.75 to 5.

Optionally, a supplementary additive such as starch enzyme or oxidizing agent to attack the polymers in the filtercake can be included. There are helpful if the design temperature is less than about 70° C. (about 160° F.); above this temperature the released acid is capable of destroying the polymer.

Optionally, a surfactant can be included, if required or helpful.

The release of the organic acid from the acid precursor is slow. For example, depending upon temperature, about two days can be required for all the acid to be released. For this reason, it is preferred that when the breaker fluid has been placed in the zone, an isolation device (e.g., a flapper or ball valve) be closed to isolate the treated section from the hydrostatic pressure. Otherwise, as the filtercake and near well bore damage may be degraded sufficiently to allow fluid losses, which would probably occur in a non-uniform manner along the open hole, then the remainder of the unreacted treatment fluid can be lost to the formation and the filtercake may not be attacked as fully as possible. Isolation is not required in all formations, however.

Acid precursors of this type are obviously not as powerful as a strong acid such as hydrochloric acid, but they do have several advantages. For example, the entire interval can be exposed to the acid because the fluid placed into the openhole section is essentially neutral and as the acid is liberated subsequently. There is less corrosion potential because the pH of the treatment fluid is self-buffered at pH about 4. There are very few health, safety, and environmental (“HSE”) concerns associated with the acid precursors. In addition, there is no need for special storage tanks or handling equipment because neutral pH fluids are being handled.

The most commonly used acid precursor is a carboxylate ester, although other acid precursors are contemplated. The reaction with water can be represented as follows regarding an example with a formate ester:

R-formate+H₂O→formic acid

A comparison of the reaction rate of carboxylate ester and acetic acid with finely ground calcium carbonate showed that the reaction with acetic acid is extremely rapid, whereas the reaction for carboxylate ester continues over an extended period.

If the design temperature is above about 70° C., the released acid can hydrolyse starch.

When the released formic acid reacts with calcium carbonate, the system becomes self-buffered at around pH 4. (Other carboxylate esters can produce organic acids that buffer at a somewhat higher pH.)

A carboxylate ester releases acid on hydrolysis. A carboxylic ester can react with water and upon hydrolysis it releases an organic acid. Depending on type of ester selected, such as a formate, actetate, or lactate, the respective acid is released such as formic acid, acetic acid or lactic acid. Concentration of the carboxylate ester in a treatment fluid preferably ranges from about 5% v/v to about 20% v/v

The solvents for such a carboxylate ester can be water, brine (NaCl, NaBr, CaCl₂, etc).

Acid Corrosion of Metals

In general, “corrosion” is the loss of metal due to chemical or electrochemical reactions, which could eventually destroy a structure. The corrosion rate will vary with time depending on the particular conditions to which a metal is exposed, such as the amount of water, pH, other chemicals, temperature, and pressure. Examples of common types of corrosion include, but are not limited to, the rusting of metal, the dissolution of a metal in an acidic solution, oxidation of a metal, chemical attack of a metal, electrochemical attack of a metal, and patina development on the surface of a metal.

Corrosion of metals can occur anywhere in an oil or gas production system, such as in the downhole tubulars, equipment, and tools of a well, in surface lines and equipment, or transportation pipelines and equipment. Carbon steel commonly used in wells includes, without limitation, J55 steel, N-80 steel, and P-110 steel. In contrast, aluminum is less commonly used in wells.

The expense of repairing or replacing corrosion damaged equipment is extremely high. The corrosion problem is exacerbated by the elevated temperatures encountered in deeper formations. The increased corrosion rate of the ferrous and other metals comprising the tubular goods and other equipment results in quantities of the acidic solution being neutralized before it ever enters the subterranean formation, which can compound the deeper penetration problem discussed above. In addition, the partial neutralization of the acid from undesired corrosion reactions can result in the production of quantities of metal ions that are highly undesirable in the subterranean formation.

Acidic fluids are present in a multitude of operations in the oil and gas industry. For example, acidic fluids are often used in wells penetrating subterranean formations. Such acidic fluids may be used, for example, in stimulation operations or clean-up operations in oil and gas wells. In operations using acidic fluids, metal surfaces of piping, tubing, pumps, blending equipment, downhole tools, etc. may be exposed to the acidic fluid.

As mineral acids are stronger acids than organic acids, mineral acids tend to be more corrosive than organic acids. In addition, at elevated temperatures the dissociation rate increases significantly, and hence, all else being equal, an acid becomes more corrosive.

Even weakly acidic fluids can be problematic in that they can cause corrosion of metals. As used herein with reference to the problem of corrosion, “acid” or “acidity” refers to a Bronsted-Lowry acid or acidity.

The mechanism of corrosion for both cases (mineral acids and organic acids) is expected to be same, the only difference is in the rate of corrosion. The rate of corrosion will depend upon the availability of H⁺ ion released from acid. Mineral acids dissociate completely to give more H⁺ ions as compared to organic acids.

Iron and Steel Corrosion

Iron is a chemical element with the symbol Fe (from Latin: ferrum) and atomic number 26. It is a metal in the first transition series. It is the most common element (by mass) forming the planet Earth as a whole, forming much of Earth's outer and inner core. It is the fourth most common element in the Earth's crust. Iron exists in a wide range of oxidation states, −2 to +8, although +2 and +3 are the most common. Elemental iron is reactive to oxygen and water. Fresh iron surfaces appear lustrous silvery-gray, but oxidize in normal air to give iron oxides, also known as rust. Unlike many other metals which form passivizing oxide layers, iron oxides occupy more volume than iron metal, and thus iron oxides flake off and expose fresh surfaces for corrosion.

Pure iron is softer than aluminum, but iron is significantly hardened and strengthened by impurities from the smelting process, such as carbon. A certain proportion of carbon (between 0.2% and 2.1%) produces steel, which may be up to 1,000 times harder than pure iron. Crude iron metal is produced in blast furnaces, where ore is reduced by coke to pig iron, which has high carbon content. Further refinement with oxygen reduces the carbon content to the correct proportion to make steel.

Carbon steel is steel where the main interstitial alloying constituent is carbon. As the carbon content rises, steel has the ability to become harder and stronger through heat treating, but this also makes it less ductile. Regardless of the heat treatment, higher carbon content reduces weldability. In carbon steels, the higher carbon content lowers the melting point. The typical composition of carbon steel is an alloy of iron containing no more than 2.0 wt % of carbon.

The term “carbon steel” may also be used in reference to steel which is not stainless steel; in this use carbon steel may include alloy steels.

The American Iron and Steel Institute (AISI) defines carbon steel as the following: “Steel is considered to be carbon steel when no minimum content is specified or required for chromium, cobalt, molybdenum, nickel, niobium, titanium, tungsten, vanadium or zirconium, or any other element to be added to obtain a desired alloying effect; when the specified minimum for copper does not exceed 1.04 percent; or when the maximum content specified for any of the following elements does not exceed the percentages noted: manganese 1.65, silicon 0.60, copper 0.60.”

Generally speaking, carbon steels contain up to 2% total alloying elements and can be subdivided into low-carbon steels, medium-carbon steels, high-carbon steels, and ultrahigh-carbon steels. Low-carbon steels contain up to 0.30% C. Medium-carbon steels are similar to low-carbon steels except that the carbon ranges from 0.30 to 0.60% and the manganese from 0.60 to 1.65%. Ultrahigh-carbon steels are experimental alloys containing 1.25 to 2.0% C.

Steels and low carbon iron alloys with other metals (alloy steels) are by far the most common metals in industrial use, due to their great range of desirable properties and the abundance of iron. Steel is commonly used in oilfield tubulars and equipment.

For example, carbon steel is usually used in tubes for the production of oil, for example “N-80”, “J-55”, or “P-110,” having the following typical composition ranges, by weight: 0.20% to 0.45% C; 0.15% to 0.40% Si; 0.60% to 1.60% Mn; 0.03% maximum S; 0.03% maximum P; 1.60% maximum Cr; 0.50% maximum Ni; 0.70% maximum No; 0.25% maximum Cu; and balance Fe (greater than 94%).

Without being limited by any theory, it is believed the corrosion of steel is attributable to the reactivity of iron (Fe). Corrosion of iron alloys such as steel is expected to occur much faster and uninhibited compared to aluminum. Thus, iron and its alloys are much more susceptible to corrosion than aluminum in acidic solutions. For example, in contrast to aluminum, steel is attacked quite rapidly by all concentrations of acetic acid even at room temperature. Therefore, steel is normally unacceptable for use in acetic acid service. Bruce D. Craig, “Hand Book of Corrosion Data,” 2nd edition, Page 88.

In the range of pH about 4 to about 10, the corrosion rate of iron or steel is relatively independent of the pH of the solution. In this pH range, the corrosion rate is governed largely by the rate at which oxygen reacts with absorbed atomic hydrogen, thereby depolarizing the surface and allowing the reduction reaction to continue.

For acidic pH values below 4, ferrous oxide (FeO) is soluble. Thus, the oxide dissolves as it is formed rather than depositing on the metal surface to form a film. In the absence of the protective oxide film, the metal surface is in direct contact with the acid solution, and the corrosion reaction proceeds at a greater rate than it does at higher pH values. It is also observed that hydrogen is produced in acid solutions below a pH of 4, indicating that the corrosion rate no longer depends entirely on depolarization by oxygen, but on a combination of the two factors (hydrogen evolution and depolarization).

For pH values above about 10, the corrosion rate is observed to fall as pH is increased. This is believed to be due to an increase in the rate of the reaction of oxygen with Fe(OH)₂ (hydrated FeO) in the oxide layer to form the more protective Fe₂O₃ (note that this effect is not observed in deaerated water at high temperatures).

As used herein, the term “carbon steel” does not include stainless steel.

Stainless steel differs from carbon steel by the amount of chromium present. Unprotected carbon steel rusts readily when exposed to air and moisture. This iron oxide film (the rust) is active and accelerates corrosion by forming more iron oxide, and due to the dissimilar size of the iron and iron oxide molecules (iron oxide is larger) these tend to flake and fall away.

Stainless steels contain sufficient chromium to form a passive film of chromium oxide, which prevents further surface corrosion and blocks corrosion from spreading into the internal material of the metal, and due to the similar size of the steel and oxide molecules they bond very strongly and remain attached to the surface. Passivation only occurs if the proportion of chromium is high enough and in the presence of oxygen. In metallurgy, stainless steel, also known as inox steel or inox from French “inoxydable,” is defined as a steel alloy with a minimum of 11.5% chromium content by weight. Stainless steel does not corrode, rust, or stain with water as ordinary steel does, but despite the name it is not fully stain-proof, most notably under low oxygen, high salinity, or poor circulation environments. It is also called corrosion-resistant steel or CRES when the alloy type and grade are not detailed. Stainless steel is used where both the properties of steel and resistance to corrosion are required.

Without being limited by any theory, inhibitors that work on the polymer film-forming phenomenon are expected to work similar on metals such as aluminum or carbon steel. However, those that work on the adsorption phenomenon of inhibitor molecules on the surface of the metal are expected to have different inhibition efficiencies on aluminum and carbon steel because their adsorption efficiencies will depend upon the chemical nature of the metal.

Corrosion Inhibition

To combat this potential corrosion problem in operations with acidic fluids, corrosion inhibitors have been used to reduce corrosion to metals and metal alloys with varying degrees of success.

A drawback of some conventional corrosion inhibitors is that certain components of these corrosion inhibitors may not be compatible with the environmental standards in some regions of the world. For example, quaternary ammonium compounds, mercaptan-based compounds, and “Mannich” condensation compounds have been used as corrosion inhibitors. However, these compounds generally are not acceptable under stricter environmental regulations, such as those applicable or that will become applicable in the North Sea region. Consequently, operators in some regions may be forced to suffer increased corrosion problems, resort to using corrosion inhibitor formulations that may be less effective, or forgo the use of certain acidic treatment fluids.

Another drawback of some conventional corrosion inhibitors is the high cost.

As used herein, the term “inhibit” or “inhibitor” refers to slowing down or lessening the tendency of a phenomenon (e.g., corrosion) to occur or the degree to which that phenomenon occurs. The term “inhibit” or “inhibitor” does not imply any particular mechanism, or degree of inhibition.

Accordingly, the term “corrosion inhibitor” means a material that has the property of reducing, slowing down, or lessening the tendency to corrosion.

Henna or Extracts as Corrosion Inhibitor

Henna (Lawsonia inermis, also called henna tree) is a flowering plant used since antiquity to dye skin, hair, fingernails, leather and wool. The name is also used for dye preparations derived from the plant, and for the art of temporary tattooing based on those dyes. Henna is the Persian name of a shrub known as Lawsonia inermis Linn. It is native to Asia and the Mediterranean coast of Africa, However, now it is spread to other parts of the world with warmer climate also. Henna leaves are harvested throughout the year, dried and ground to a fine powder for different applications including medicinal but largely for use in cosmetics. Bhuvaeshwari, K., Poongothai, S. G., Kurvilla, A., and Raju, B. A., (2002) Inhibitory Concentration of Lawsonia Inermis Dry powder for Urinary Pathogens, Indian J. Pharmacol, 34, 260-263.

Biologically, henna is classified as follows: Kingdom: Plantae; Division: Magnoliophyta; Class: Magnoliopsida; Order: Myrtales; Family: Lythraceae; Subfamily: Lythroideae; Genus: Lawsonia; Species: Lawsonia inermis.

The leaves of henna contain naphthoquinones. Naphthoquinones are a class of organic compounds derived from naphthalene. At least three isomers are normally included: 1,2-naphthoquinone; 1,4-naphthoquinone, of which the Vitamin K group compounds are derivatives; and 2,6-naphthoquinone (amphi-naphthoquinone).

A hydroxynaphthoquinone refers to a naphthoquinone derivative wherein any number n of the hydrogens have been replaced by n hydroxyls, so that the formula is C₁₀H₆O₂₊ₙ. In this case the number n (which is between 1 and 6) is indicated by a multiplier prefix (mono-, di-, tri-, tetra-, penta-, or hexa-).

The main naphthoquinone extracted from henna is 2-hydroxy-1,4-napthoquinone, also known as also known as hennotannic acid, and which is commonly known as lawsone. Thomson, R. H., Naturally Occurring Quinones, Academic Press, London, N.Y. 1971. For example, lawsone can be extracted from henna leaves with heated water at about 70 C for 4 hours. Then adding NaHCO3 and filtering. The filtrate is then acidified to a pH of about 3 with aqueous HCl solution. The resulting solution is then extracted with diethyl ether. The crude lawsone can finally be purified, for example, by column chromatography. Dananjaya, S. H. S., Edussuriya, M., and Dissanayake, A. S., Inhibition Action of Lawsone on the Corrosion of Mild Steel in Acidic Media, The Online Journal of Science and Technology, April 2012, Volume 2, Issue 2.

Structurally, lawsone has two oxygen atoms attached to the naphthalene carbons at positions 1 and 4, which form 1,4-naphthoquinone, and a hydroxyl (—OH) group is present at position 2, which forms the 2-hydroxy-1,4-napthoquinone.

Lawsone is a ligand that can chelate with various metal cations to form metal complexes. Therefore, the formation of insoluble complexes, by chelating of the metal cations with the lawsone molecules adsorbed on the metal surface, is a probable interpretation of the observed inhibition action of lawsone.

In an acidic medium, protonation of 2-hydroxy-1,4-napthoquinone takes place. This can allow for the reversible tautomerization of the molecule to 4-hydroxy-1,2-napthoquinone. Accordingly, it is believed that 2-hydroxy-1,4-napthoquinone or 4-hydroxy-1,2-napthoquinone would work equally well according to the methods.

Henna is an example of a readily available plant source for one or more hydroxynaphthoquinones. Another source of lawsone is jewelweed (Impatiens balsamina). Biologically, jewelweed is classified as follows: Kingdom: Plantae; Order: Ericales; Family: Balsaminaceae; Genus: Impatiens L. Jewelweed is also known to have alkaloids.

In addition to lawsones, henna, jewelweed, or their extracts are believed to contain some alkaloids. Hydroxynaphthoquinones have oxygen atoms and alkaloids have N and S atoms. It is believed that can any of these hydroxynaphthoquinones or alkaloid molecules can be adsorbed on a carbon steel surface. Without being limited by any theory, it is believed that this adsorption can block the discharge of H⁺ and dissolution of metal ions. According to the invention, it is believed that any of the hydroxynaphthoquinones or alkaloids that can be extracted from henna or jewelweed would function as a corrosion inhibitor for carbon steel. Due to the presence of heteroatoms in the molecules of henna or jewelweed leaf extract or hydroxynaphthoquinones, it is believed that the inhibition mechanism is based on the adsorption phenomenon.

Accordingly, it is contemplated that any of the plants that produce hydroxynaphtholenes would be useful according to the present invention.

It is contemplated that it may not be necessary to extract from the plant prior to use as a corrosion inhibitor. For example, the plant material is expected to release at least some of the active corrosion inhibitor into the fluid, especially if used in the fluid at an elevated temperature (above Standard Laboratory Conditions up to as high as about 300° F.). Accordingly, for example, a material of any of the plants that produce hydroxynaphthoquinones, are contemplated by this invention. It is contemplated that such a material be in the form of a ground or powdered plant material. In addition, it is believed the hydroxynaphthoquinones are formed primarily in the leaves of such plants, and, accordingly, material from the leaves is preferred.

In addition, it is contemplated that other sources of hydroxynaphthoquinones, including synthetic hydroxynaphthoquinones, would be suitable for use according to the invention. Natural plant sources of hydroxynaphthoquinones are expected to be cheaper than synthetic sources, however.

The presently most preferred hydroxynaphthoquinone for use according to the invention is lawsone.

Henna, jewelweed, and their extracts are sometimes used for medicinal purposes and are generally recognized for being biodegradable.

Henna, jewelweed, and their extracts are expected to be compatible with aqueous acid formulations commonly used in fluids used in wells.

Further, both the solid powder and the liquid extract of these plants, being natural plant compounds, are extremely safe to handle during transportation and use at the field locations. There are no reported values of flammability, reactivity and hence is not a health or environmental hazard.

Hence, the extract of henna or jewelweed, either in solid powder or aqueous liquid form, can be used for application as a corrosion inhibitor in acid treatments worldwide. The use of extract of henna as a corrosion inhibitor can satisfy the long pending requirements of North Sea oil operations. The present invention provides a very simple effective natural and environmentally green product to inhibit corrosion in different types of acids.

In view of the points highlighted above, henna, jewelweed, and their extracts can serve as an excellent choice for a corrosion inhibitor for delayed-release organic acids and also comply with all health, safety and environment standards.

Preferably, the hydroxynaphthoquinone is selected from the group consisting of: 2-hydroxy-1,4-napthoquinone; 4-hydroxy-1,2-napthoquinone; and any combination thereof.

The plant extract can in particulate form when being mixed in the step of forming the fluid. Alternatively, the extract can be in a liquid solution form when being mixed in the step of forming the fluid.

As these materials are derived from plant sources, it is believed that any of them would be biodegradable. Preferably, the material used as a corrosion inhibitor is biodegradable according to a test for biodegradability.

Preferably, the corrosion inhibitor material is a concentration in the range of from about 0.01% wt/vol to about 20% wt/vol of the aqueous acid solution. More preferably, the material is combined with the aqueous acid solution in an effective amount to provide at least measurable corrosion inhibition for the metal to be contacted by the fluid in the well under the design conditions of contacting.

Corrosion Inhibitor Intensifier

A corrosion inhibitor intensifier enhances the effectiveness of a corrosion inhibitor over the effectiveness of the corrosion inhibitor without the corrosion inhibitor intensifier. According to a preferred embodiment of the invention, the corrosion inhibitor intensifier is selected from the group consisting of: formic acid and potassium iodide.

Preferably, the fluid additionally comprises a corrosion inhibitor intensifier. Corrosion inhibitor intensifiers can be selected, for example, from the group consisting of potassium iodide, cuprous chloride, antimony-based compounds, bismuth-based compounds, and any combination thereof.

The corrosion inhibitor intensifier is preferably in a concentration of at least 0.1% by weight of the fluid. More preferably, the corrosion inhibitor intensifier is in a concentration in the range of 0.1% to 20% by weight of the fluid. More preferably, the corrosion inhibitor intensifier is combined with the aqueous fluid in an effective amount to provide at least measurable corrosion inhibition improvement for the metal to be contacted by the fluid in the well under the design conditions of contacting.

Optional Additives

In an embodiment, the fluid used according to the method includes a viscosity-increasing agent. The viscosity-increasing agent can be used, for example, to help suspend a particulate in the fluid. Preferably, the viscosity-increasing agent is selected from the group consisting of starch, a starch derivative, guar, a guar derivative, a cellulose derivative, xanthan, a xanthan derivative, diutan, a diutan derivative, and any combination thereof.

In an embodiment including a viscosity-increasing agent, the fluid can additionally include a crosslinking agent for the viscosity-increasing agent.

A fluid for use in a method according to the invention can also include, for example, one or more additives selected from the group consisting of weighting agents, surfactants, surface modifying agents, gas, nitrogen, carbon dioxide, foamers, bases, buffers, alcohols, conventional corrosion inhibitors, scale inhibitors, catalysts, clay control agents, biocides, friction reducers, antifoam agents, bridging agents, dispersants, flocculants, H₂S scavengers, CO₂ scavengers, oxygen scavengers, lubricants, oxidizers, breaker aids, relative permeability modifiers, particulate materials, resins, tackifying agents, wetting agents, coating enhancement agents, and any combination thereof.

Additional Steps or Conditions

According to an embodiment of the invention, the method includes the steps of: forming a fluid according to the invention; and introducing the fluid into a well.

A fluid can be prepared at the job site, prepared at a plant or facility prior to use, or certain components of the fluid can be pre-mixed prior to use and then transported to the job site. Certain components of the fluid may be provided as a “dry mix” to be combined with fluid or other components prior to or during introducing the fluid into the well.

In certain embodiments, the preparation of a fluid can be done at the job site in a method characterized as being performed “on the fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing.

Often the step of introducing a fluid into a well is within a relatively short period after forming the fluid, for example, within 30 minutes to one hour. More preferably, the step of delivering the fluid is immediately after the step of forming the fluid, which is “on the fly.”

It should be understood that the step of introducing or delivering a fluid into a well can advantageously include the use of one or more fluid pumps.

In an embodiment of the methods, the treatment fluid is a drilling fluid, and the fluid is introduced while drilling a portion of the well.

After the acid is spent in the well for its intended purpose, the fluid can be flowed back from the well.

The methods can be used at a design temperature of at least 200° F. Preferably, the design temperature is less than 300° F.

### Example Fluid-Loss Control Application

Methods according to the invention can have various applications in a well. For example, after application of a filtercake, it is often desirable to restore the permeability of the formation. If the formation permeability of the desired producing zone is not restored, production levels from the formation can be significantly lower. Any filtercake or any solid or polymer filtration into the matrix of the zone resulting from a fluid-loss control treatment must be removed to restore the formation's permeability, preferably to at least its original level. This is often referred to as clean up.

Chemicals used to help remove a filtercake are called breakers.

Breakers for helping to remove a filtercake must be selected to meet the needs of each situation. First, it is important to understand the general performance criteria for breaking. Premature destruction of a filtercake can cause undesired fluid loss into a formation. Inadequate breaking of a filtercake can result in permanent damage to formation permeability. A breaker for removing a filtercake should be selected based on its performance in the temperature, pH, time, and desired filtercake profile for each specific fluid-loss application.

No particular mechanism is necessarily implied by breaking or breaker regarding a filtercake.

A filtercake can be removed, for example, by dissolving the bridging particulate, chemically degrading the viscosity-increasing agent, reversing or breaking crosslinking if the viscosity-increasing agent is crosslinked, or a combination of these. More particularly, for example, a bridging agent can be selected for being insoluble in water but soluble in acid, whereby changing the pH or washing with an acidic fluid can dissolve the bridging agent. Chemically degrading the viscosity-increasing agent, reversing or breaking crosslinking if the viscosity-increasing agent is crosslinked, can be another technique for removing a filtercake.

For example, a method for breaking a filtercake can include the use of an acidizing fluid. Another method for breaking a filtercake can include the use of a delayed-release acid in a fluid that forms the filtercake.

### Examples

To facilitate a better understanding of the present invention, the following examples of certain aspects of some embodiments are given. In no way should the following examples be read to limit, or define, the entire scope of the invention.

Static Corrosion Weight-Loss Test Procedure

Static weight-loss corrosion tests are performed as follows. High pressure, high temperature (“HPHT”) static weight loss corrosion testing was performed in individual HASTELLOY™ model B-2 autoclaves.

A metal is selected based on the particular metal of interest. The metal can be a metal alloy. A metal specimen is cleaned by degreasing with acetone followed by removal of the surface scale by lightly bead blasting the surface. Each specimen is accurately measured in square inches and accurately weighed in grams. Weighing of the metal specimens (sometimes referred to in the art as “coupons”) was on a balance accurate to at least the nearest 1 mg, preferably to the nearest 1/10 mg to determine the initial or first weight.

A test fluid is prepared by mixing the desired components.

For example, a test fluid is mixed by first adding a specified concentration of a water-soluble salt, if any, and a specified volume of deionized water to a mixing container. The container is placed on a mixer base. The motor of the base is then turned on and maintained at approximately 2,000 revolutions per minute (rpm) for approximately 60 seconds (s) (+/−1 s) until all the salt is in solution. The container is then removed from the mixer base, and a specified concentration of a carboxylate is added to a desired volume of the salt-water solution. The container is then placed on a magnetic stirrer plate and the fluid is stirred with a magnetic stirring rod for approximately 5 min. A specified concentration of the corrosion inhibitor is then added to the fluid and stirred on the magnetic stirring plate for approximately 5 min. It is to be understood that the test fluid is mixed at about Standard Laboratory Conditions.

The metal specimen is hung in a glass container as a test cell using a Teflon® rod or tape. The specimen is ensured to hang in about the middle of the container such that no part of the specimen touches the wall of the container.

The test fluid is then poured into the container gently, down the side of the container so no air bubbles are trapped around the metal specimen. The glass container is filled such that the metal specimen is immersed completely. The volume of the test fluid to metal surface area ratio should be about 20 milliliters/inch². The glass container is then capped with a Teflon® lid.

After capping the test cell, the container with the test fluid and the metal specimen are placed in the autoclave. The autoclave is filled with a heat transfer medium (that is, mineral oil) and pressurized to a desired test pressure (for example, about 500 psi or about 1,000 psi) with nitrogen gas. Heating can be accomplished using controllers that adjust a specific heating ramp up to the test temperature, preferably via computer control. Pressure is maintained using a back pressure regulator assembly that allows for automatic bleed-off of any excess pressure developed during heating and corrosion.

The aging cell is placed into an oven, pre-heated to the specified temperature for the specified time. The aging cell is allowed to cool for at least one hour. Test times are contact times and include heat up and cool down times. The test times are the total contact time of the test fluid with the metal specimen.

The cell is then de-pressurized. The metal specimen is removed from the test fluid and from the container. The specimen is disassembled from the rod and any corrosion surface products are removed by washing with 15% hydrochloric acid, followed by water, and then acetone. The dried specimen is weighed on the balance accurate to at least the nearest 1 mg, preferably to the nearest 1/10 mg to determine the final or second weight.

The corrosion weight loss (CWL) is calculated for the specimen using the following equation and is reported in units of pounds per square feet (lb/ft²).

CWL=(weight loss)(0.3175)/(surface area)

where weight loss=initial weight minus final weight in grams; and surface area=the total surface area of the metal plate exposed to acid in square inches (in²). A corrosion weight loss of less than about 0.05 lb/ft² for the required contact time can be considered acceptable.

The corrosion rate (CR) for each plate can also be calculated as follows, expressed in units of mils per year lost (mpy), wherein “mils” is defined as 1/1,000 of an inch:

CR=(WL*22,300)/(A*d*t)

where: WL=weight loss in grams; A=surface area of plate in inches²; d=density of the plate in grams per square centimeters (g/cm²); and t=time of exposure of the plate to a corrosive environment in days.

Experimental details, including test fluid compositions, type of metal alloy specimen, and the testing time and temperature, are discussed below.

Corrosion Testing and Results

Static weight-loss corrosion tests were conducted as generally described above.

Table 2 shows the blank test fluid (without corrosion inhibitor) and test conditions using a delayed breaker.

TABLE 2
Experimental Conditions for Delayed-Breaker CorrosionTests

| Parameter | Units | Value |
|---|---|---|
| Sodium-chloride brine | lb/gal | 9.2 |
| | (ppg) | |
| A carboxylate ester that releases | % (v/v) | 10 |
| a short chain (C1-C4) | | |
| carboxylic acid (an internal | | |
| delayed-acid breaker for a | | |
| filtercake) | | |
| Test coupon | None | 1010 Steel |
| Test temperature | ° F. | 200 |
| Test pressure | psi | 500 |
| Test duration | days | 7 |

Table 3 shows corrosion testing performed with the blank test fluid or with added henna at 200° F. for 7 days showed corrosion losses greater than 0.05 lb/ft² which is above the acceptable limit Addition of 120 lb/Mgal of potassium iodide (KI) as corrosion inhibitor intensifier resulted into corrosion loss of 0.0336 lb/ft². This indicates that the corrosion inhibitor intensifier is working in synergy with henna as the corrosion inhibitor.

TABLE 3
Corrosion Loss at 200° F. for 7 Days

| | | Corrosion | | |
|---|---|---|---|---|
| | Corrosion | Inhibitor | | |
| | Inhibitor | Intensifier | | |
| | (Henna) | (KI) | Corrosion | |
| | concentration | concentration | Loss | |
| S. No | g/100 ml | (lb/Mgal) | (lb/ft²) | Final pH |
| 1 | — | — | 0.4126 | 5.06 |
| 2 | 4 g | — | 0.0682 | 1.90 |
| 3 | 4 g | 120 | 0.0336 | 1.71 |

Another set of testing was conducted with henna as a corrosion inhibitor in 15% hydrochloric acid (HCl) with metal type P110. Table 4 shows the blank test fluid and the test conditions for this test.

TABLE 4
Experimental Conditions for 15% HCl CorrosionTests

| Parameter | Units | Value |
|---|---|---|
| HCl | % (v/v) | 15 |
| Test coupon | None | P110 Steel |
| Test temperature | ° F. | 200 |
| Test pressure | psi | 1,000 |
| Test duration | hours | 3 |

Table 5 shows the performance of henna in 15% HCl. Corrosion testing performed with added henna at 200° F. for 3 hours showed corrosion losses greater than 0.05 lb/ft², which is above the acceptable limit. Addition of 120 lb/Mgal of potassium iodide as a corrosion inhibitor intensifier resulted into decreased corrosion loss of 0.0142 lb/ft², which is very much acceptable according to the industry standard.

TABLE 5
Corrosion Loss with Inorganic Acid
(15% HCl) at 200° F. for 3 Hours

| | Corrosion | Corrosion Inhibitor | |
|---|---|---|---|
| | Inhibitor (Henna) | Intensifier (KI) | Corrosion |
| | concentration | concentration | Loss |
| S. No. | (g/100 ml) | (g/100 ml) | (lb/ft²) |
| 4 | 4 | None | 0.0856 |
| 5 | 4 | 1.4 | 0.0142 |

The above data demonstrates the corrosion inhibition properties of henna for use with an acid breaker for a filtercake. The corrosion examples with henna in the presence of a corrosion inhibitor intensifier (potassium iodide) in carboxylate ester show good performance in terms of corrosion losses.

The corrosion examples with henna in the presence of corrosion inhibitor intensifier (potassium iodide) in carboxylate ester shows good performance in terms of corrosion losses as is evident from Table 3. The test conditions and results are summarized in Table 2 and 3 respectively.

### CONCLUSION

Therefore, the present invention is well adapted to attain the ends and advantages mentioned as well as those that are inherent therein.

The exemplary fluids disclosed herein may directly or indirectly affect one or more components or pieces of equipment associated with the preparation, delivery, recapture, recycling, reuse, or disposal of the disclosed fluids. For example, the disclosed fluids may directly or indirectly affect one or more mixers, related mixing equipment, mud pits, storage facilities or units, fluid separators, heat exchangers, sensors, gauges, pumps, compressors, and the like used generate, store, monitor, regulate, or recondition the exemplary fluids. The disclosed fluids may also directly or indirectly affect any transport or delivery equipment used to convey the fluids to a well site or downhole such as, for example, any transport vessels, conduits, pipelines, trucks, tubulars, or pipes used to fluidically move the fluids from one location to another, any pumps, compressors, or motors (e.g., topside or downhole) used to drive the fluids into motion, any valves or related joints used to regulate the pressure or flow rate of the fluids, and any sensors (i.e., pressure and temperature), gauges, or combinations thereof, and the like. The disclosed fluids may also directly or indirectly affect the various downhole equipment and tools that may come into contact with the chemicals/fluids such as, but not limited to, drill string, coiled tubing, drill pipe, drill collars, mud motors, downhole motors or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

The various elements or steps according to the disclosed elements or steps can be combined advantageously or practiced together in various combinations or sub-combinations of elements or sequences of steps to increase the efficiency and benefits that can be obtained from the invention.

The various elements or steps according to the disclosed elements or steps can be combined advantageously or practiced together in various combinations or sub-combinations of elements or sequences of steps to increase the efficiency and benefits that can be obtained from the invention.

The invention illustratively disclosed herein suitably may be practiced in the absence of any element or step that is not specifically disclosed or claimed.

Furthermore, no limitations are intended to the details of construction, composition, design, or steps herein shown, other than as described in the claims.

1. A method of treating a portion of a well, the method comprising the steps of:
(A) forming a fluid comprising:
(i) an aqueous liquid phase; and
(ii) a corrosion inhibitor selected from the group consisting of:
(a) the leaves of henna, jewelweed, or any combination thereof;
(b) an extract of the leaves of henna, jewelweed, or any combination thereof;
(c) a plant source of a hydroxynaphthoquinone;
(d) a hydroxynaphthoquinone; and
(e) any combination an any of the foregoing; and
(B) introducing the fluid into the portion of the well.

2. The method according to claim 1, wherein the fluid is a water-based fluid.

3. The method according to claim 1, wherein the aqueous liquid phase comprises a water-soluble inorganic salt.

4. The method according to claim 1, wherein the aqueous liquid phase comprises one or more salts selected from the group consisting of alkali metal halides.

5. The method according to claim 1, wherein the aqueous liquid phase additionally comprises an acid such that an initial pH is less than about 4.

6. The method according to claim 5, wherein the acid comprises HCl.

7-12. (canceled)

13. The method according to claim 1, wherein the hydroxynaphthoquinone is selected from the group consisting of: 2-hydroxy-1,4-napthoquinone; 4-hydroxy-1,2-napthoquinone; and any combination thereof.

14. The method according to claim 1, wherein the extract is in particulate form when being mixed in the step of forming the fluid.

15. The method according to claim 1, wherein the extract is in a liquid solution form when being mixed in the step of forming the fluid.

16. The method according to claim 1, wherein the corrosion inhibitor is a concentration in the range of from about 0.01% wt/vol to about 20% wt/vol of the aqueous liquid phase.

17. The method according to claim 1, wherein the fluid additionally comprises a corrosion inhibitor intensifier.

18. The method according to claim 17, wherein the corrosion inhibitor intensifier is selected from the group consisting of: potassium iodide, cuprous chloride, antimony-based compounds, bismuth-based compounds, and any combination thereof.

19. The method according to claim 1, wherein the fluid additionally comprises a viscosity-increasing agent.

20. The method according to claim 1, wherein a design temperature is at a temperature of at least 200° F.
